(19) United States
(12) Patent Application Publication
(10) Pub. No.: US 2002/0057682 A1
(43) Pub. Date: May 16, 2002

(54) UNIVERSAL SERIAL BUS TELEPHONY INTERFACE

(76) Inventors: JOSEPH MICHAEL HANSEN, LONG BEACH, CA (US); DORIS ANN MATTINGLY, HUNTINGTON BEACH, CA (US)

Correspondence Address: RAYMOND VAN DYKE, JENKENS & GILCHRIST, 3200 FOUNTAIN PLACE, 1445 ROSS AVENUE, DALLAS, TX, 752022799

(21) Appl. No.: 09/161,612

(22) Filed: Sep. 24, 1998

(51) Int. Cl. H04L 12/56

(52) U.S. Cl. 370/386; 370/402

(57) ABSTRACT

A system and method for a Universal Serial Bus (USB) device supporting both PSTN and DECT external interfaces. A USB device has distinct and dedicated external interfaces for providing multi-functionality capabilities. The host PC coordinates device interfacing through separate interface drivers associated with the USB device external interfaces. Future replacement of either external interface functionality is allowed without effecting the host PC driver or firmware architecture.

### BACKGROUND OF THE INVENTION

1. Technical Field of the Invention

The present invention relates to computer and communication systems, and more particularly to systems and methods that support multifunctional peripheral devices using a Universal Serial Bus (USB).

2. Description of Related Art

A recent entry into the personal computer (PC) world is the Universal Serial Bus (USB). A USB is typically used to connect peripheral devices to a PC. USB supports data transmission rates of over 10 Mbits/s, and as such is suitable for supporting real-time video and/or audio applications.

Moreover, USB provides a simple, universal interface for a wide range of USB compliant devices including digital joysticks, scanners, speakers, digital cameras, monitor controllers and, essentially, any other devices traditionally adapted for the various PC interfaces. With USB, these devices all share a common interface and therefore there is a potential for dramatic increases in their interaction and enhanced functionality, especially in light of the high data transmission rates supported by USB.

A particular application that can benefit from USB is computer telephony. Computer telephony is a field of computer and telephony integration in which a PC telephone peripheral provides voice telephony and, through software running on an associated host PC, more advanced services, e.g. management of voice, data and fax mail boxes, call routing services, etc.

Most recently, the personal wireless network, a version of PC telephony, has emerged as a viable communications alternative for the small office and home environments. The personal wireless network is a radio frequency network utilizing a personal computer (PC) as a communications center. The personal wireless network promises to enable the consumer the capability of printing documents, interchanging files and accessing the Internet, regardless of where the PCS, printers and telephone jacks are installed and used. Other electrical systems will also be controlled by the computer. For example, users will be able to arm their alarm system by speaking a simple command into a lightweight cordless telephone handset. In short, the personal wireless network utilizes high speed interfaces, such as the USB, for availing real-time communications in a network essentially all of the abovementioned wireless and wired devices.

One of the challenges with these emerging fields of personal communications exists in providing interfaces to different communication resources. In a conventional USB configured computer telephony system, for example, a separate USB peripheral device is typically required to interface or otherwise support different types of external/internal communications systems. Thus, for example, a first peripheral device (hub) would be required to access a PSTN. In order to also provide access to a significantly different telecommunication system, such as, a Digital Enhanced Cordless Telecommunications (DECT) system, a second peripheral device would be required. Adding peripheral devices, such as these, tends to make the computer telephony system more complex and more costly.

Thus, as can be appreciated, there is a need for improved systems and methods that allow for different communications networks to be interfaced through a single peripheral device.

### SUMMARY OF THE INVENTION

In accordance with certain aspects of the present invention, the peripheral device includes a common control interface and at least two external interfaces. This configuration allows for different communications networks to be interfaced through a single peripheral device.

In accordance with certain further aspects of the present invention, the peripheral device is connected to a host computer that is configured to further coordinate the peripheral device interfacing function, for example, using a plurality of interface drivers associated with various interfaces within the peripheral device. In accordance with certain preferred embodiments of the present invention, the peripheral device and host computer are part of a computer telephony system, and the peripheral device is connected through the external interfaces to at least a PSTN and a DECT network. The above stated needs are also met by way of a method for interfacing a USB to a plurality of external networks.

### BRIEF DESCRIPTION OF THE DRAWINGS

A more complete understanding of the method and apparatus of the present invention may be had by reference to the following detailed description when taken in conjunction with the accompanying drawings wherein:

FIG. 1 is a USB architecture on which the present invention may allow improvement upon;

FIG. 2 depicts the prior art USB modularity structure;

FIG. 3 depicts a single or dual function USB device in association with a host PC in a single logical interface relation; and

FIG. 4 is an preferred embodiment depicting a multifunctional USB device with multiple external interfaces for supporting the multiple functions in association with a host PC providing multiple logical interfaces therefor.

### DETAILED DESCRIPTION OF THE PRESENTLY PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

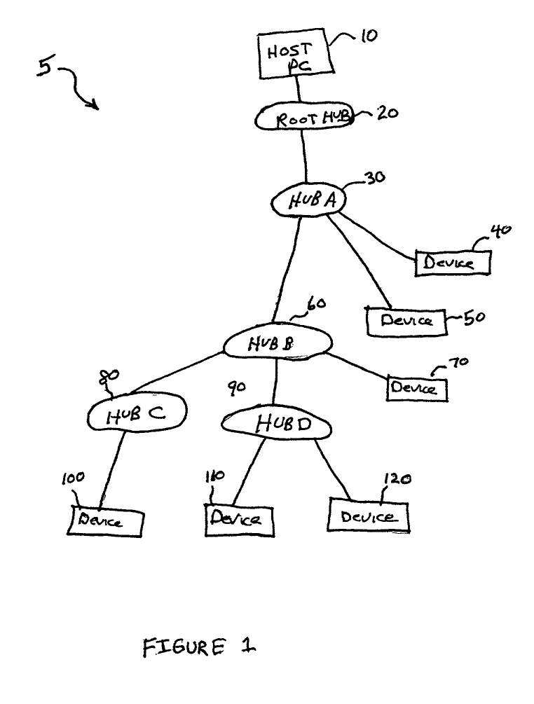

In FIG. 1 is shown a typical USB system 5 architecture. The USB couples USB devices and hubs to a USB host PC 10. At the root of the USB architecture is a root hub 20. Root hub 20 is directly integrated into the host PC 10 to provide one or more device or hub attachments. The USB interface at the host PC 10 is referred to as the host controller and controls all communications on the bus, i.e., all communications between the host PC 10 and hubs or devices coupled thereto via the USB.

Elements of the USB system 5 architecture may be generally designated as hubs or devices excluding the USB host 10 and the physical interconnect itself. A USB hub is a USB element which provides additional attachment points to the USB. USB devices are functions which provide specific capabilities to the USB system, e.g., a DECT connection, digital mouse, etc. USB hubs and devices exhibit a standard, compatible USB interface to the USB system 5 in terms of their common incorporation of the USB protocol and ability to response to standardized USB operations commands, e.g., configuration and resets. USB devices and hubs are required to be able to self identify and basic configuration.

USB devices and hubs are accessible by the host PC 10 by a unique USB address and each device and hub support at least one endpoint, each endpoint capable of being receiving communications from host PC 10. Regardless of the number of endpoints supported by a given device or hub, at least one of the endpoints is designated Endpoint 0 and is coupled to the respective devices or hubs control pipe. Associated with the control pipe of each device is data specifying the USB device. Standardized information included in this specifying data includes device or hub manufacturer and power management specifications. USB devices and hubs are accessible by the host PC via the respective control pipe.

Physical layout of the USB system 5 is made in a multi-tiered manner with the host PC 10 at the root. Directly therebelow is a root hub 20 which serves to provide multiple attachment points thereto. Attachments include USB devices or other hubs. In the illustrative example, root hub 20 couples hub A 30 to USB system 5. Hub A 30 provides multiple additional attachment points on which devices 40 and 50 and hub B 60 are connected. Hub B 60 similarly connects hub C 80 and hub D 90 and, additionally, device 70. Hub C 80 couples a single device 100 and hub D 90 completes the USB system 5 by coupling device 110 and device 120 thereon. Each of the devices and hubs in USB system 5 are accessible by host PC 10 via a common access method.

The distinct functionality between the hubs and the devices should be apparent. Hubs provide only additional attachment capability by converting a single attachment point into multiple attachment points, or ports. Status and control commands specific to a hub allow the host PC 10 to monitor and control its ports and, thus, any device attached thereto.

Devices transmit and receive data and control signals over the USB system 5. Generally a device is implemented as a distinct peripheral with a USB cable for attachment directly with a single port of a hub. Examples of USB devices include a USB mouse, keyboard, or communications adapter. USB host PC 10 and any of the devices communicate either in a uni-directional or bi-directional manner with the data or control transfers taking place between software operating on the control PC 10 and a particular endpoint of a specific device independently from any other PC host 10 communication with any other device endpoint in an association referred to as a pipe. These pipes may be directional in nature, i.e., a particular pipe may service transfers from a device endpoint to the host PC 10 while another pipe services transfers from the host PC 10 to the same device endpoint.

USB provides two different pipes, namely a stream pipe and a message pipe. USB also defines four basic transfer types: control, bulk, interrupt or isochronous. Each of these is supported by either a stream or message pipe. Control commands used to configure a device by the host PC 10 are transferred over a control pipe. Large amounts of sequential data, e.g., printer transmissions, are typically transmitted over a bulk pipe. Transmission over a bulk pipe utilize any available bandwidth not being consumed by other data transfer types. Interrupt data transferred over a interrupt pipe include data that is not governed by an explicit timing rate, i.e., spontaneous data transfers, that is often interactive in nature. Isochronous pipes are responsible for transferring data that is continuous, or real-time, in nature such as voice data or compressed video. Isochronous data transfers taking place over an isochronous pipe (i.e., a stream pipe) are typically timing sensitive. Timing is maintained in isochronous pipe transfers at the expense of neglecting error correction.

With reference now to FIG. 2, the modular definition of USB software architecture is depicted. The host PC 10 interface to the USB, or the USB host controller 200, is controlled via the USB host controller driver 210. The USB driver 220 provides device driver-level interfacing for interfacing an actual device with the host controller. The USB device driver 230 is the client software responsible for operating a specific USB class/peripheral.

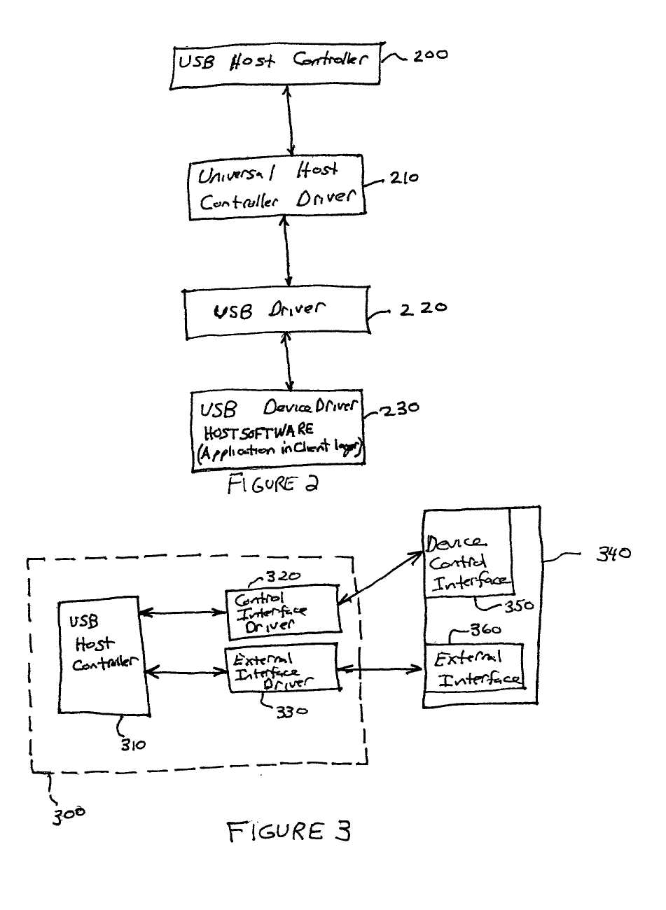

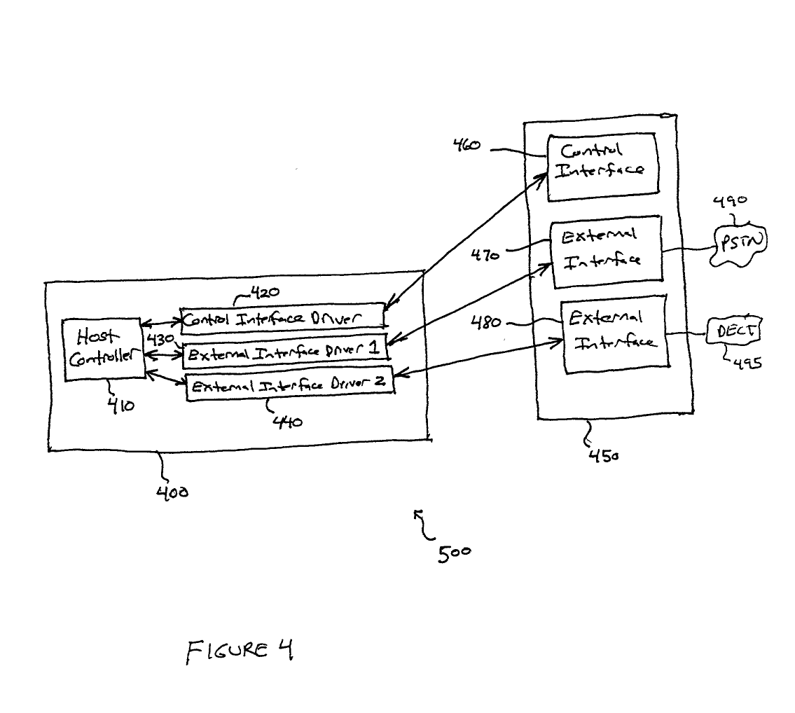

With reference now to FIG. 3 is shown the host PC 300 interfacing for a typical single or dual function external device 340. USB Host Controller 310 directs external device 340 commands from control interface driver 320 which itself communicates directly with external device control interface 350 via standardized control pipe communications. Isochronous and bulk communications are also directed by host controller 310 through external interface driver 330 which communicates with external device 340 through isochronous and bulk pipes communications over external interface 360.

As aforedescribed, devices providing multi-functionality between disparate external sources have been unable to interface with the standardized external interface driver 330. While some dual function devices may have both functions directly interfaced with the external interface driver 330, diverse functions, such an interfacing between two significantly different communication systems, e.g. DECT and an analog communications system such as the PSTN, are not feasibly supported by the standardized external device driver.

In FIG. 4 is shown an exemplary USB system 500 of the present invention providing multiple interfacing for a device 450 with diverse, multifunctional capabilities. Host PC 400 has integrated therein the USB interface, host controller 410 which coordinates control interface 420 and external interfaces 430 and 440. Control interface 420 is a standard USB control interface for transmitting and receiving control data to and from the control interface of device 450 according to standardized USB protocols. Communications between control interface 420 and the control interface 460 of device 450 can take place over a control pipe (i.e., the default pipe), with additional bulk pipe and/or an interrupt pipe. All interfaces use the default (i.e., control) pipe, by definition. Device 450 is directly addressable by host controller 410 through this interface may receive bulk transmissions such as firmware downloads or other non-timing sensitive transfers capable of being transferred as available bandwidth allows. Any spontaneous data transfers not explicitly timed are allowed transmission over an interrupt pipe in the control interface.

In a preferred embodiment, device 450 is a USB compliant personal wireless network base station that provides multi-functionality between a DECT and PSTN external interface. External interface 470 provides a switching interface between device 450 and PSTN 490 allowing voice switching between device 450 and communication devices operating therefrom (not shown). Real-time voice data may be transmitted from device 450 over an isochronous pipe coupling the external interface driver 430 of PC host 400 and the external interface 470 of device 450. The peripheral's control pipe and interrupt pipe are also utilized by external interface driver 430 and external interface 470 for transmission of control and interrupt data therebetween. In a preferred embodiment, four isochronous pipes are available for communication between peripheral device 450 and servicing external interfaces 470 and 480. Two of the isochronous pipes are used to provide data transfers from external interfaces 430 and 440 to external interfaces 470 and 480, respectively, The other two isochronous pipes are used for data transfers from external interfaces 470 and 480 to external interface driver 430 and 440, respectively.

External interface 480 provides control of the air interface which, in a preferred embodiment, is operated in accordance with the DECT protocol. The DECT protocol stack is controlled by the base station directly over external interface 480 which itself communicates via the peripheral's control pipe and interrupt pipe coupling external interface 480 and external interface driver 440.

By dividing the functionality of device 450 into three logical interfaces, replacement of either of the external interfaces is enabled without impacting the host PC 400 drivers or firmware architecture. If the functionality of interfacing the PSTN and DECT had been incorporated into a single external interface on device 450 and an associated interface driver on host PC 400 as provided by current USB standards, replacement of either interface would require concurrent replacement of the remaining interface driver and firmware infrastructure. By providing a dedicated interface for each of the external systems, the above-mentioned issue is avoided.

Although a preferred embodiment of the method and apparatus of the present invention has been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claims.

What is claimed is:

1. A computer telephony system comprising:
a host computer;
a bus connected to the host computer and configured to carry isochronous data; and
a peripheral device connected to the bus, the peripheral deice having a common control interface and at least two external interfaces configured to support access to at least two different communication networks.

2. The system as recited in claim 1, wherein the bus is a Universal Serial Bus (USB).

3. The system as recited-in claim 2, wherein the at least two different communication networks includes a PSTN and a DECT network.

4. The system as recited in claim 2, further comprising, for each of the at least two external interfaces, a corresponding external interface driver within the host computer.

5. The system as recited in claim 1, wherein the common control interface is configured to control at least a portion of the at least two external interfaces.

6. An apparatus for use in a computer telephony system having a host computer and a bus that is connected to the host computer and configured to carry isochronous data, the apparatus comprising:
a common control interface arranged to be connected to the bus; and
at least two external interfaces arranged to be connected to the bus and to at least two different communication networks, and configured to be responsive to one more signals from the common control interface.

7. The apparatus as recited in claim 6, wherein the common control interface and the at least two external interfaces are each arranged to be connected to a Universal Serial Bus (USB).

8. The apparatus as recited in claim 7, wherein the at least two different communication networks includes a PSTN and a DECT network.

9. A method for use in a computer telephony system having a host computer and a bus that is connected to the host computer and configured to carry isochronous data, the method comprising:
providing a common control interface within a peripheral connected to a isochronous configured bus;
using a first external interface within the peripheral device to connect the bus to a first type of communication network, the first external interface being responsive to one more signals from the common control interface; and
using a second external interface within the peripheral device to connect the bus to a second type of communication network, the second external interface being responsive to one more signals from the common control interface.
